(19) United States
(12) Patent Application Publication
(10) Pub. No.: US 2012/0080419 A1
(43) Pub. Date: Apr. 5, 2012

(54) Clip-on Heater

(75) Inventors: Simon Peter Bush, Ambler, PA (US); Nellie Luna Cabato, Plymouth Meeting, PA (US); Laurence Nathaniel Wesson, Blue Bell, PA (US)

(73) Assignee: AURORA OPTICS, INC., Broad Axe, PA (US)

(21) Appl. No.: 13/237,594

(22) Filed: Oct. 18, 2011

Related U.S. Application Data
(60) Provisional application No. 61/403,850, filed on Sep. 22, 2010.

(51) Int. Cl. H05B 1/00; H05B 3/06

(52) U.S. Cl. 219/385

(57) ABSTRACT

A device is disclosed for the heat processing of cables, wires, fibers, and the like which is small, light, and configured to be disposed temporarily directly on the cable to be heated in situ. Typically the device comprises a heat generation element or elements and supporting shells arranged so as to form an elongated cavity, a housing to provide an insulating enclosure around the cable so as to form a heated chamber, temperature sensing means to monitor the heating for closed-loop control, and means to enable the heater to hold itself onto the cable or wire in situ. Power and control means with electrical processing capability are provided to supply power to the heater, monitor the temperature inside the heater cavity, and govern the time and temperature which the device applies to the cable or wire in order to process it, for instance to apply a heat shrink sleeve.

### FIELD OF THE INVENTION

This invention relates to a device for causing desirable changes in the characteristics of a cable, wire, or fiber by the application of heat. Commonly cables are reinforced, insulated, stiffened, and the like by the application of an adhesive-lined sleeve which, when heated, shrinks substantially to tighten and seal around a particular portion of the cable. This invention addresses means of performing this operation which are unusually small, light-weight, and configured to be applied directly onto the cable without moving it from where it might already be in service or applying any undue stresses.

### DESCRIPTION OF THE PRIOR ART

Heat shrink sleeves have been used on cables and wires of various kinds for many years. Such sleeves commonly consist of a tube of polyolefin which is lined internally with a smaller tube or layer of adhesive, commonly polyamide or ethyl vinyl acetate (EVA) “hot melt” glue. There is an entire military specification for these products, MIL-PRF-23053. When heat is applied to the sleeve, typically over 100 C, the outer tube contracts radially, usually by a factor of 3 or 4. At the same time the inner layer softens to a soft gel-like consistency. As the sleeve is heat treated, it shrinks tightly onto the cable while the glue layer spreads and fills the voids. When the sleeve is then allowed to cool, the treated portion of cable is tightly enclosed and sealed. In electrical wires and cables this process is commonly used to insulate bare conductors after they have been spliced, as by soldering, crimping, or fixing in a terminal block. Alternately, glue-lined heat shrink sleeves may be used to fix and seal strength member yarns, repair tears or cuts in a cable's outer sheath, or attach break-out boots or “furcations”. In another application, heat shrink sleeves may be applied to individual insulated wires to increase their effective outer diameter. This may be important to insure that such wires fit snugly into the elastomeric grommets or glands in connectors, which are provided to seal onto the wires and prevent ingress of water or other contaminants into the connectors. It has been found that as wire technology has improved over the years, smaller conductors and thinner insulation can carry the same power or signals that larger wires did formerly, but many connectors, especially MIL-spec connectors, have sealing grommets or holes that were designed for the older and larger wires. The newer thinner wires sometimes do not seal properly in existing grommets and glands, potentially allowing leakage of contaminants into the connector. Heat shrink sleeves applied to the thinner wires can bulk up their diameter suitably so that they seal properly in such grommets or glands.

Besides these uses, in fiber optic cables heat shrink sleeves are commonly used to seal, protect, and reinforce fusion splices. Optical fibers must be stripped of their protective coatings and cleaned to bare glass before splicing, but this process leaves the fibers weakened and vulnerable to damage from humidity, tension, bending, and other stresses. For protection and reinforcement after splicing they are commonly overlaid with heat shrink sleeves. Such sleeves include not only the two layers mentioned above, but also a steel wire or thin rod disposed inside the outer polyolefin tube but parallel with the inner polyamide or EVA layer, so that when the sleeve has been shrunk onto the bare spliced fiber the glue completely encapsulates the bare fiber and fixes it with relation to the wire, within the outer tube. The wire protects the fiber against bending and tensile stresses while the two plastic layers protect it against humidity, immersion, dust, and other environmental attack.

A newer application is the restoration of fiber optic cables after splicing, in which both a) the strength member yarns of the cables must be substantially rejoined to restore tensile strength to the repair, b) the repaired area must be sealed against leakage or environmental attack, c) the repair should be as flexible as possible, and d) the repair must be rugged enough to survive modest handling to restore the cable to its desired location or configuration. Methods are being developed to make such cable restorations using MIL-PRF-23053 heat shrink sleeves. Applying a first, thinner, glue-lined heat shrink sleeve on a fusion spliced fiber provides a first layer of protection. The strength member yarns from the two cable sides is then overlapped over the first and inner heat shrink sleeve. A second and larger glue-lined heat shrink sleeve is then shrunk over the entire repair area. As the glue spreads within this outer sleeve it penetrates the overlapped strength member yarns and glues them together, restoring a substantial level of tensile strength to the repair, and by filling the outer sleeve it encapsulates everything within, providing further seal and protection against environmental attack.

To cause a heat shrink sleeve to shrink onto a wire, cable, or fiber, one of two methods has generally been adopted. The first is the public domain heat gun, similar to a hand-held hair dryer. Examples of current heat guns appear in the catalogs of many electrical, industrial, and fiber optic distributors. See for instance the catalogs of Techni-Tool, Grainger, Lowes, and McMaster-Carr.¹ Heat guns generally consist of a blower and high temperature resistance-heated coils in a ducted package configured to blow hot air where desired. Commonly both the temperature and the air flow rate can be controlled at different levels suitable for the needs of particular heat processing tasks. To process a heat shrink sleeve on a cable, the heat gun is used to direct hot air, usually well over 100 C, onto and around the heat shrink sleeve, positioned where desired on the cable, until it shrinks properly. Heat guns have advantages of low cost, common availability, and some control of temperature, and they can often be applied to cables in situ, but they have serious disadvantages. In explosive atmospheres typical of many locations, such as fuel depots, aircraft hangers and flight decks, refineries, mines, and mills, the red hot resistance heating coils pose an unacceptable risk of igniting flammable vapor. Even in safe environments, the heat gun requires considerable expertise and attentiveness on the part of the user. Heating the heat shrink sleeve too hot or too long may damage the plastic coatings on the cable, wire, or fiber, or even the sleeve itself. Heating unevenly, so as to shrink the ends of the sleeve before the center, can trap air bubbles inside, which in the long run will lead to bending stresses on an optical fiber and possibly failure. When a cable is in a hard-to-reach location it may be difficult or impossible to maneuver the heat gun so as to blow and heat evenly on all sides, with resulting uneven and possibly incomplete shrinkage of the heat shrink sleeve. Inadvertent under-heating may leave the sleeve incompletely sealed and leave the wire or fiber subject to environmental attack. Worse, some of these potential problems are not obvious to casual inspection, so ¹ See http://www.techni-toolcatalog.com/lg_display.cfm/catalog/130/page/228/highlight/heat%20gun, http://www.grainger.com/Grainger/heat-guns/power-tools/ecatalog/N-amg?contexPath=Grainger&xi=xi, http://www.lowes.com/SearchCatalogDisplay?Ntt=heat+gun&storeId=10151&N=0&1angId=-1&catalogId=10051, http://www.memaster.com/#heat-guns/=e28dbj

a defective result may be accepted and left in place inadvertently, only to fail later when the consequences may be serious and the cost of repair high. And because the heat gun must transmit heat to an object by blowing air, it must consume a large amount of power relative to what is needed intrinsically to shrink a heat shrink sleeve, making it impractical to power with a portable battery.

The other common tool for heat-processing fibers and cables is the heat shrink oven. Again, many examples are available commercially, for instance from Power & Tel and Corning Cable Systems.² The heat shrink oven generally consists of an elongated semi-cylindrical trough or shell laminated at least partially with an electrically heated element, a cover or closure, an insulated housing, temperature sensing means, and means for power and control. The cable to be heat-processed, with the heat shrink sleeve positioned properly, is laid into the trough and the cover closed onto it. Often clamping means are also provided to hold the cable generally straight while it is being processed. When activated by the user, the control circuit applies power to heat the element and trough, creating a hot environment inside the enclosure to heat-process the cable. The sensing means, often a thermistor, monitors the temperature in the cavity. The controller is commonly programmed to apply heat first or hottest to the center of the trough so as to prevent the capture of bubbles when the sleeve shrinks, raise the temperature rapidly so as to minimize the processing time, pause heating when the optimum temperature is reached, control and maintain the optimum temperature for a predetermined time to insure complete shrinkage, and then stop when a predetermined cycle time has been completed.

Advantages of the heat oven are that unless misadjusted it will not over-heat or under-heat the cable, it will not trap bubbles, it will consistently deliver well-controlled cable processes, it uses much less power than a heat gun so it can be powered from a portable battery if necessary, and it can be adjusted for a variety of needs, conditions, or cables. ² See http://www.ptsupply.com/pdf/Catalog/Hardware%20&%20Supplies/Fiber%20Optic%20Supplies.pdf and http://catalog2.corning.com/CorningCable Systems/media/Resource_Documents/products_Family_specifications_rl/EVO-638-EN.pdf

Since it does not use open resistance-heated coils to heat flowing air it can be packaged to minimize explosion hazard in hazardous atmospheres. Among the serious disadvantages, however, are typically much higher cost than a heat gun and the fact that the oven is bench-mounted or substantially packaged. Many heat ovens even package their own batteries internally, further adding to the size and weight of the over all device³. Unlike with the heat gun, the operating philosophy is that a cable is to be brought to the oven, not the oven to the cable. In many situations, for instance original installations and fusion splicing of fibers, this is acceptable. But in many other situations particularly including repair it is inconvenient, impractical, or even impossible to move the cable from where it happens to be and bring it to the oven, compact though the oven be. ³ See e.g. the HSO-II heater manufactured by TriTec Developments LTD: http://www.tritec.biz/Downloads/hsods.pdf

US patent application no. 2005/0123253, Ryuichiro Sato, discloses a heat oven for spliced optical fibers with a particular design of the heated trough. However, it is clear from the title (“Optical Fiber Fusion Apparatus”) and FIGS. 1, 2, 6, 7, and particularly 14 that the invention is employed in a bench mount configuration. And because the invention is only intended for optical fibers as an adjunct of the fusion splicing process, it is reasonable, indeed normal, to expect the fibers to be brought to the bench mounted equipment, never the other way around.

U.S. Pat. No. 7,699,540, Miyamori et al, discloses an improved method and apparatus for processing optical fiber reinforcement, i.e. heat shrink sleeve. This invention is basically a new method of timing the heater on and off for improved heating in otherwise ordinary heat ovens, and therefore does not address the challenges of the present application. U.S. Pat. No. 7,412,146, Sato et al, discloses a splice protection heater capable of quickly and efficiently heating, a fusion splicer embodying the improved heater, and a fusion splicing method. U.S. Pat. No. 7,128,478, Takahashi et al, discloses a method for insuring that the center of an optical fiber splice is centered in the heat shrink sleeve before the sleeve is heated. U.S. Pat. No. 7,040,818, Ryuichiro Sato, discloses a heat shrink heater for spliced optical fibers in which the fiber clamps and the heating element are all individually adjustable in height, the better to optimize the heating process. U.S. Pat. Nos. 6,518,551 and 6,437,299, both Watanabe et al, teach heat shrink ovens for spliced optical fibers in which two or more heating elements are controlled independently to improve the heating results. And U.S. Pat. No. 4,460,820 discloses an early version of heat shrink heater for optical fibers which explicitly includes “a base”. While the teachings of all these patents may be of value in many contexts, as with the previous reference and considering both their specifications and their drawings it is clear that these inventions are only envisioned to be employed in apparatus of substantial size and weight (i.e. a fusion splicer) and thus only in bench mount situations.

U.S. Pat. No. 6,407,370, Sauron et al, U.S. Pat. No. 6,229,122, Assen, and U.S. Pat. No. 5,138,136, Moreau et al, all disclose methods of heating elongated members such as plastic elements or tubes in which the electrical resistance heating element(s) is wound around the tube and controlled remotely via a cable. However, these inventions all envision the heating element wound entirely around the object to be heated, and thus either not removable at all afterward or only with difficulty. In U.S. Pat. No. 5,138,136, for instance, the heat shrink element and the resistance heating element are actually combined into one assembly, and it is intended that the heating element remain permanently on the pipe or cable after processing. These heaters are by no means either “clip-on” or removable after use.

U.S. Pat. No. 4,764,662, Anderson et al, discloses a heat shrink oven with automatic ejection of the wire or cable after heat processing, but again it is obviously a bench mounted device of substantial size and weight.

U.S. Pat. No. 4,509,820, Murata et al, discloses a heat shrink sleeve for optical fibers in which the resistance heating elements are embedded in the heat shrink sleeve itself As with U.S. Pat. No. 5,138,136, the invention, while heated on the cable, is not “clip on”, and each “heater” is deliberately to be left on the fiber or cable after a single use.

U.S. Pat. No. 3,515,853, finally, discloses an early version of a heater for cables which is clamped temporarily onto a cable and which then heats it electrically from both sides.

However, this invention specifically calls for the two halves of the assembly to be “interconnected in a plier-type or sugar tong type arrangement”, in other words hand-held. Assemblies according to this invention are clearly bulky, heavy, and unsuitable for cramped or limited spaces or for suspending on cables with their own weight.

What has been lacking in the prior art is a heater for processing cables which is small and light to be disposed directly onto the cable and suspended under its own weight.

A further need is for a heater which can be disposed easily onto a cable for the duration of the processing, then easily removed afterward.

A further need is for a heater which is optimized for processing cables in difficult access locations or situations.

A further need is for a device to heat-treat cables in situ, particularly for repair, without the need to disturb them, which may be extremely difficult, expensive, or dangerous.

A further need is for a heater which can heat-process a cable in situ safely in hazardous atmospheres, by separation of low voltage from high voltage (i.e. 110 VAC) components, as by a remoting cable.

A further need is for a heater which can heat-process a cable in situ and at the same time limit its temperature below the maximum safe temperature for operation in flammable atmospheres.

A further need is for a heater which can heat-process a cable in situ with automatic control of time and temperature to optimize the heating results.

A further need is for a heater which can heat-process a cable in situ automatically and thus minimize the need for a high level of skill, attentiveness, and control on the part of the user in order to achieve uniformly correct results.

All of the above needs are provided by the instant invention.

### SUMMARY OF THE INVENTION

The problems and needs of the existing art are solved by a device for the heat treatment of cables which is small, light, and configured to be disposed temporarily directly on the cable to be heated. Typically the device comprises a heat generation element or elements and supporting shells arranged so as to form an elongated cavity, a housing to provide an insulating enclosure around the cable so as to form a heated chamber, temperature sensing means to monitor the heating for closed-loop control, and means to enable the heater to hold itself onto the cable or wire in situ. Power and control means with electrical processing capability are provided to supply power to the heater, monitor the temperature inside the heater cavity, and govern the time and temperature which the device applies to the cable, wire, or fiber in order to process it, for instance to apply a heat shrink sleeve. The power and control module may be a separate unit or, if simple enough, may be built into the clip-on heater itself.

Heat is typically generated by resistance heating of a thin serpentine conductor pattern laminated in a flexible polymer sandwich. Specific patterns, resistance values, and other characteristics of the heater element are not material to this invention, so long as sufficient heat can be generated in a reasonable time to heat the enclosure and the cable and result in proper completion of the desired process. Generally the pattern is designed to heat faster in the center, so that the proximate center of the heat shrink sleeve heats and shrinks first, so as to prevent the capture of air bubbles.

Typically the heater element is laminated onto a formative plate or shell, usually of metal, although electrically insulated from it. The metal shell is formed substantially in the shape of a semi-cylinder, much longer than wide, approximately in a U or C shape. The shell provides mechanical strength and stability to the heater and spreads the heat quickly and uniformly due to its thermal conductivity.

Adjacent to the heater and metal shell is located a temperature sensing device, typically a thermistor, resistance temperature device (RTD), or thermocouple. This gives the control circuitry the ability to monitor the temperature inside the enclosure and control the heating properly.

The forgoing components are mounted in a supporting housing. Besides holding the active components in proper relationship, the purposes of the housing are to provide the cavity within which a section of cable will be heat treated, insulate the cavity against loss of heat during processing, and grip onto the cable. Attachment onto the cable may be achieved by spring loading two hinged halves of a cylindrical housing, by latching a cover onto a U-shaped base housing, or by other means. The important point is that the housing is self-supporting on the cable, no other support being needed.

In some embodiments two halves of a basically cylindrical housing are activated by grippers and a built-in spring, much like an ordinary clothes pin (which is also designed easily to clip onto a “cable”, i.e. a clothes line). The grippers allow a user easily to open the two halves of the housing to orient it onto a cable, and when the grippers are released the built-in spring urges the two halves together to complete the closure and attachment onto the cable.

In some embodiments wires conduct heating electrical current and control signal from and to a controller.

In some embodiments the control circuitry is housed in a separate module, electrically connected by wires both to the clip-on heater and to a source of electricity. The controller may include means for the user to select heating time, heating temperature, and possibly more sophisticated parameters of a heating profile.

### BRIEF DESCRIPTION OF THE DRAWINGS

The invention will be more fully understood, and further advantages will become apparent, when reference is made to the following detailed description of preferred embodiments of the invention and the accompanying drawings, wherein like reference numerals denote similar elements throughout the several views, and in which:

FIG. 1 is a perspective view of a first embodiment of the invention, with heater elements in both halves of a clam shell type enclosure.

FIG. 2 shows another view of the first embodiment, including a cable to an optional separate control unit.

FIG. 3 shows a cross section of the first embodiment to better illustrate a layout of heating elements, temperature sensors, housing, hinge, and grippers.

FIG. 4 shows a second embodiment of the invention, with a single heating element in a lower portion of the device and a latched cover.

### DETAILED DESCRIPTION OF THE INVENTION

This invention relates to a device and method for causing desirable changes in the characteristics of a cable, wire, or fiber by the application of heat. Commonly cables are reinforced, insulated, stiffened, and the like by the application of an adhesive-lined sleeve which, when heated, shrinks substantially to tighten and seal around a particular portion of the cable. This invention addresses means of performing this operation which are unusually small, light-weight, and disposed to be applied directly onto the cable without moving it from where it might already be in service.

The following detailed description of preferred embodiments is intended to be illustrative, not limiting. It will be understood that alternative applications will be readily apparent to those skilled in the art, which are not described herein in detail but which nevertheless fall under the coverage of the appended claims.

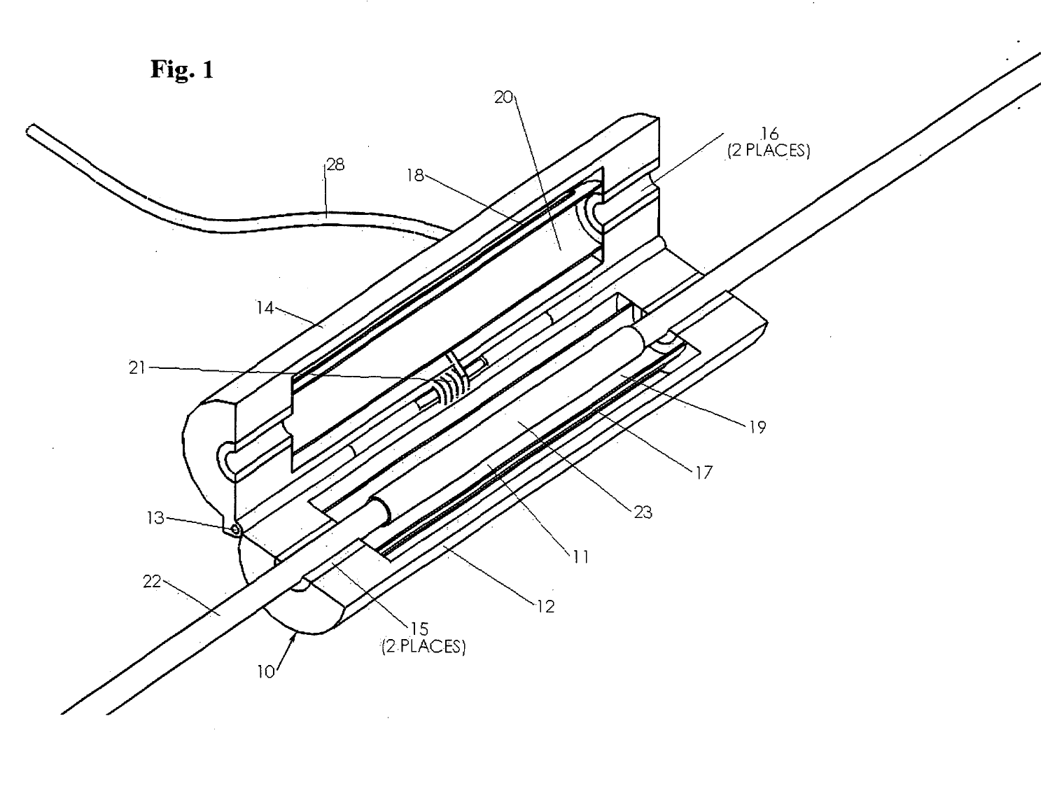

FIG. 1 illustrates a first embodiment of a clip-on heater 10. The structure and layout of the heater when closed generally form an extended cylinder with dimensions suitable to the type(s) of cable to be processed. For instance, when applying heat shrink sleeves to typical simplex fiber optic cables 2-3 mm in diameter, the heater may be approximately ½ inch in diameter. Given that common heat shrink sleeves used on optical fibers are 60 mm long, the clip-on heater may thus be approximately 3 to 4 inches long over all. The clip-on heater 10 consists of two similar half cylinders 12 and 14, attached together by a hinge 13.

The interior of the clip-on heater 10 is formed into a cavity 15 wherein the heat is captured to surround a cable 22 to be processed. The cavity 15 should be slightly longer than a typical heat shrink sleeve 23 to be processed, thus typically greater than 2.5 inches long, and wide enough in diameter to enclose a pre-shrinking (unshrunk) heat shrink sleeve 23 on its cable 22. For ¼ inch diameter MIL-PRF-23053 heat shrink sleeves the cavity may thus be ¼ to ⅓ inch in diameter.

At the ends of the half cylinders 12 and 14 are provided semi-cylindrical slots 15 and 16 of suitable size to capture a cable 22 reasonably securely and minimize loss of heat from the enclosure during processing.

The material of the housing is chosen to be both light, strong, stable at elevated temperatures up to typically 150 C, and thermally insulating. A good material for this purpose is filled polycarbonate, although it will be evident that a wide variety of other engineering materials is available that will also serve very well.

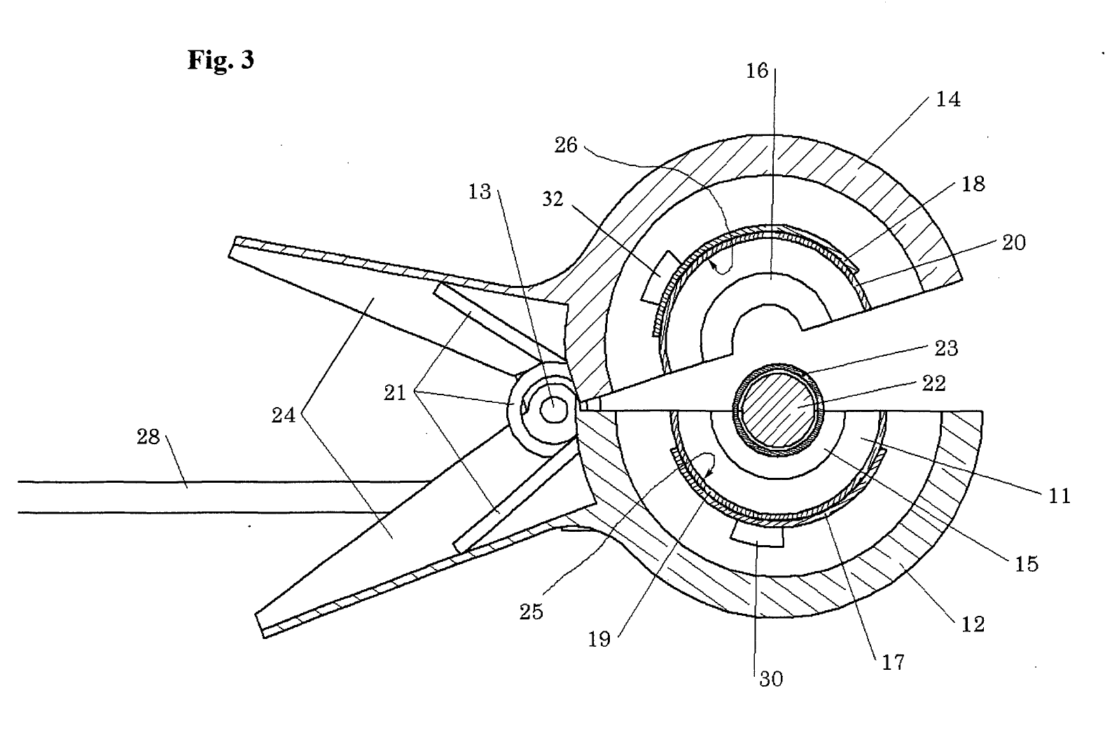

Referring now to both FIGS. 1 and 3, there is provided a spring 21 within grippers 24. By pinching the grippers 24 together the user causes the two halves of the enclosure 12 and 14 to spring apart against the force of the spring 21. When open the clip-on heater 10 can easily be positioned onto or off a cable 22 to be processed. When the user releases the grippers 24 the restoring force of the spring 21 causes the two halves of the device to close together again. When the clip-on heater 10 is positioned on a cable 22, the force of the spring 21 is sufficient to hold the two halves of the enclosure 12 and 14 securely enough so that the weight of the clip-on heater 10 will not cause it to come loose or fall off.

Within the clip-on heater 10 are disposed heating elements 17 and 18 laminated onto semi-cylindrical metal shells 19 and 20. The heating elements 17 and 18 consist of serpentine conductive patterns made of a resistance heating alloy laminated in an insulating plastic matrix. They may be designed to draw a current of 1.5 A at 12 VDC while heating to a maximum temperature of 150 C. This is a key advantage, because 150 C is both high enough to guarantee complete shrinkage of any MIL-PRF-23053 heat shrink sleeve and also safely below the maximum safe temperature to prevent ignition of flammable hydrocarbon vapors (typically 185 C). Thus the device is both effective and safe in hazardous environments. The metal shells 19 and 20 are substantially U- or C-shaped in cross section and complementary to each other, so that when the two halves of the heater 12 and 14 are closed onto a cable 22 and heat shrink sleeve 23 the two metal shells 19 and 20 are oriented with respect to each other to form a virtually complete hollow cylinder with a minimal gap between their edges. The two metal shells 19 and 20 are each approximately ⅓ inch in diameter and 3 inches long and may be made for instance from aluminum or another thermally conductive metal or alloy. The interior surfaces of the two half cylinders are coated with an anti-stick coating 25 and 26, for instance made of Silverstone® or Teflon®. The anti-stick coating minimizes any tendency for the materials heated in the clip-on oven 10, (e.g. extruded hot-melt glue) when hot, to stick.

Electrical leads 28 allow electrical current to be directed to the heating elements 17 and 18 to cause them to heat up in proportion to the current. In one embodiment a heater element 17 has an electrical resistance of 8.25 Ohms, and when passing a current of 1.5 A at 12 VDC it heats to 150 C in approximately 45 seconds.

Thermistors 30 and 32 are mounted on heating elements 17 and 18. By monitoring the temperature of the thermistors 30 and 32, the control circuit can control when, by how much, and with what frequency to turn the current on and off to the heating elements 17 and 18, in order best to heat-process the heat shrink sleeve 23 and cable 22.

Electrical leads 28 also allow connection between the temperature sensor(s) and the control circuitry.

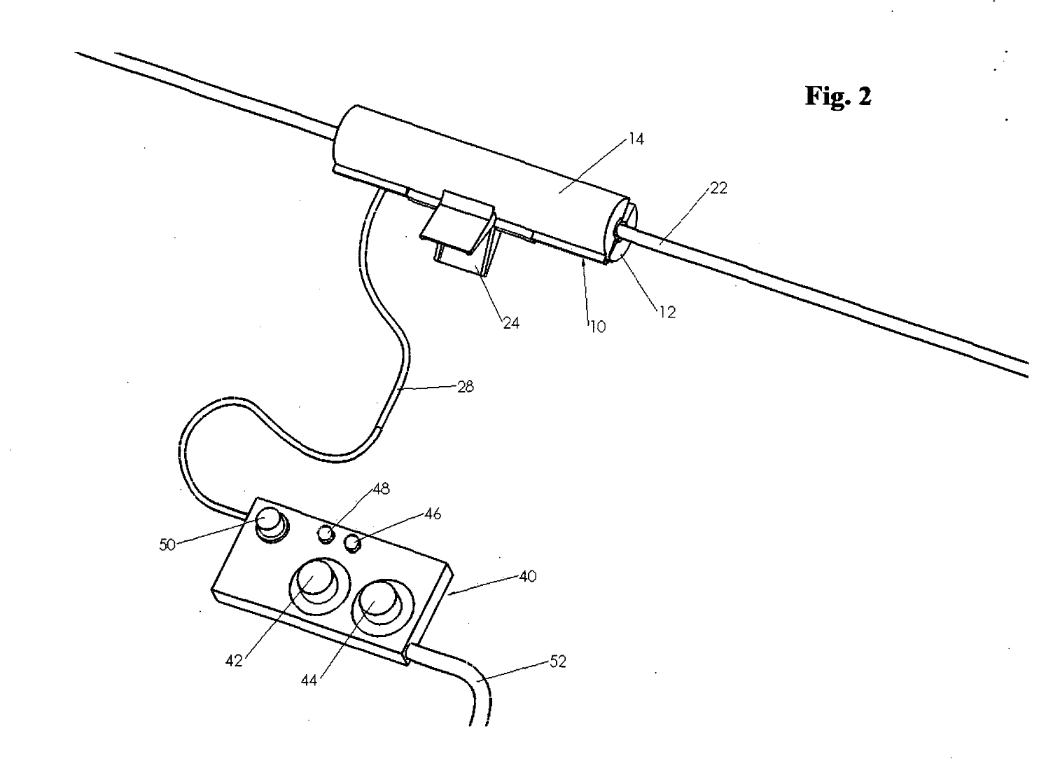

Referring to FIG. 2, in one embodiment of the invention the control circuitry may be housed in a separate module 40. Among the advantages of this configuration are that a) as little weight and size as possible remain in the clip-on heater 10, so it can most readily be disposed onto a cable 22 with minimal stress, b) more sophisticated control elements such as user I/O, processor, and/or monitor maybe be provided without adding to the weight of the clip-on heater 10, c) it may be easier to explosion-proof just the clip-on heater 10 for use in a hazardous atmosphere, because it can then be operated remotely at low voltage from a non-qualified controller via leads 28 of extended length. In the embodiment of FIG. 2, knobs 42 and 44 on controller 40 allow user adjustment of heater time and temperature, to optimize the process for any particular cable 22 and heat shrink sleeve 23. Indicator lights 46 and 48 indicate (for instance) when the clip-on heater 10 is preheating, maintaining heat, or cooling. The device is activated by switch 50. Electrical power is obtained from mains or battery via power cable 52.

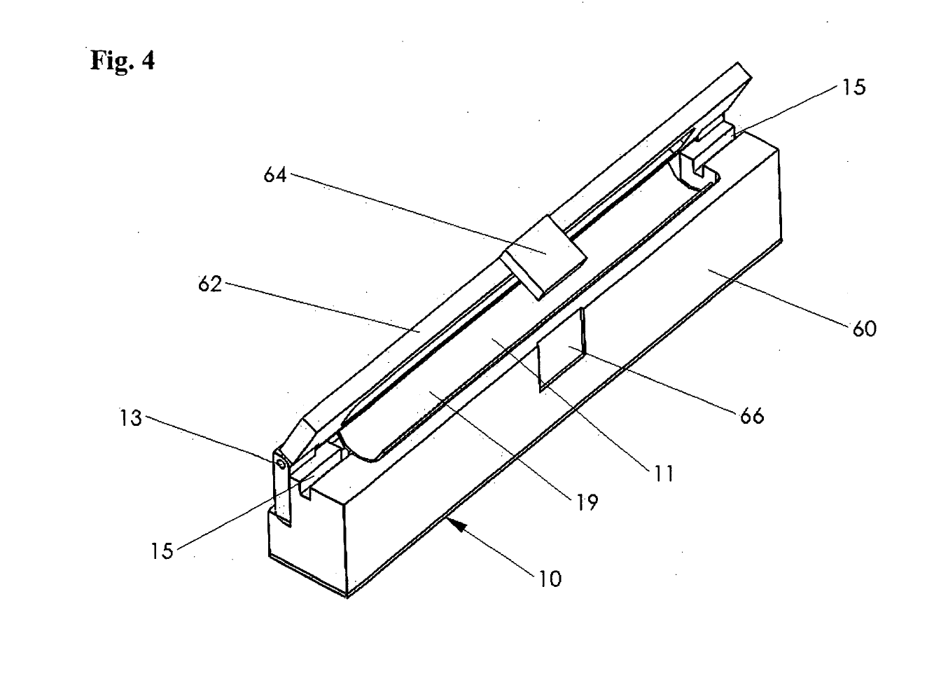

FIG. 4 shows an alternative embodiment of the present invention, in which only a single heating element (not visible) and metal half-shell 19 are needed. The enclosure 11 is formed by closing a lid or cover 62, which is moveably attached to single housing 60 by hinge 13. Instead of being held closed by a spring, the cover is held closed by latch 64 which can grip onto the housing 60 at location 66. The grip of latch 64 is strong enough to suspend the entire (small) weight of clip-on heater 10 on the cable being processed, yet easily be disengaged by the user using only fingers. The entire device is approximately ½ inch in width and 4 inches long. In this embodiment the control means (not shown) are simple and miniature enough to fit entirely in the bottom of housing 60. It will be appreciated that sophisticated user functions may be difficult to implement in such a small package, but in many applications the invention is used consistently in the same way, on similar cables and heat shrink sleeves, so it may be unnecessary to provide for adjustments or variations in the heating parameters. In such simple applications this embodiment offers advantages of simplicity, very small size and weight over all, and lower cost.

It will be appreciated from the foregoing that the invention provides a means to heat-process cables or wires in situ, without removing them from an existing disposition. It further provides a simple clip-on heat processing means which can be applied to cables in difficult access locations or situations, needing very little space and no work surface at all. It further provides a clip-on heat processing means which is automatic, minimizing variations in results due to shortcomings in operator skill, attentiveness, or working conditions. It further provides a clip-on heating means which automatically limits the heat to a level which is safe in hazardous atmospheres. It further provides a clip-on heating means which delivers uniformly good results (high yield) with minimal defects due to under-heating, over-heating, or uneven heating. It further provides that the control means may be located in a separate module and connected by a cable, which allows further reduction in the size and weight of the device.

While the invention has been described in considerable detail, it will be understood that such detail need not be strictly adhered to in practicing the invention, but that various changes and modifications may suggest themselves to those skilled in the art, all falling within the scope of the present invention as defined by the subjoined claims.

What is claimed is:

1. A device for the heat processing of cables, wires, fibers, and the like, comprising:
at least one heating element,
an elongated housing which forms an enclosure for containing heat,
means for the provision of electrical power, and
control means to control the process,
all of the foregoing being small and light advantageously to be mounted directly onto the cable, wire, or fiber being processed without imposing undue stress.

2. A device as in claim 1 wherein said elongated housing comprises at least two similar portions which together can form said enclosure for containing heat.

3. A device as in claim 2 wherein the portions of said housing are mutually attached moveably along congruent edges.

4. A device as in claim 3 wherein said mutual attachment means is in the form of a hinge.

5. A device as in claim 3 wherein means are provided for a user to cause the portions of said housing to open and close.

6. A device as in claim 3 which includes latching means to secure the portions of said housing together when closed.

7. A device as in claim 5 wherein spring means are provided to urge the portions of said housing together when released by the user.

8. A device as in claim 2 wherein each portion of said housing contains a separate heating element.

9. A device as in claim 8 wherein means are provided for a user to cause the portions of said housing to open and close.

10. A device as in claim 8 wherein spring means are provided to urge the portions of said housing together.

11. A device as in claim 8 which includes latching means to secure the portions of said housing together when closed.

12. A device as in claim 4 wherein one portion of said housing is a lid or cover.

13. A device as in claim 1 wherein said heating element is a resistance heater.

14. A device as in claim 1 wherein the temperature of said heating element is controlled never to exceed 150 C.

15. A device as in claim 1 wherein said control means are contained in a separate module.

16. A device as in claim 15 wherein interconnection between said housing and said control means is made by electrical wires.

17. A device as in claim 1 wherein said control means automatically controls the heating process.

18. A device as in claim 17 wherein said control means accepts user settings of time and/or temperature of the heating process.

19. A device as in claim 1 which includes means for monitoring the temperature within said housing.
